(19) United States
(12) Patent Application Publication
(10) Pub. No.: US 2015/0244451 A1
(43) Pub. Date: Aug. 27, 2015

(54) AIRBORNE NETWORK EXTENSION CLUSTER

(71) Applicants: Anders Baeckman, Goeteborg (SE); Fredrik Dicander, Moelndal (SE)

(72) Inventors: Anders Baeckman, Goeteborg (SE); Fredrik Dicander, Moelndal (SE)

(73) Assignee: SAAB AB, Linkoeping (SE)

(21) Appl. No.: 14/418,996

(22) PCT Filed: Aug. 9, 2012
(86) PCT No.: PCT/SE2012/050867

§ 371 Date: Mar. 12, 2015

(51) Int. Cl. H04B 7/185

(52) U.S. Cl. CPC H04B 7/18504; H04W 84/06

(57) ABSTRACT

The object of the present invention is to provide an over-the-horizon communication system comprising at least two end nodes, the end nodes being configured to receive and transmit communication signals, and providing communication between the at least two end nodes. The system further comprises at least two, in the troposphere and/or stratosphere airborne, network extension nodes that are communicatively connected to the end nodes and wherein the end nodes are arranged for bidirectional or uni-directional communication with the network extension nodes and the network extension nodes are arranged for bidirectional or uni-directional communication between the individual network extension nodes and bidirectional or unidirectional communication with the end nodes.

### TECHNICAL FIELD

The present invention relates to an over-the-horizon communication system comprising at least two end nodes and at least two airborne network extension nodes, the end nodes and the network extension nodes being configured to receive and transmit communication, and providing communication between the end nodes, and methods for using, managing, deploying and providing said over-the-horizon communication system.

### TECHNICAL BACKGROUND

The invention discloses a method to manage over-the-horizon communication by use of network extension nodes. The network extension nodes form a network extension cluster, with the network extension cluster meaning a network consisting of more than one unit. Over-the-horizon communication systems, also known as beyond-the-horizon communicating systems, began to be an interesting area of research during the cold war, starting in the 1950s, and has been considered to be an important area on and off ever since. This applies both to ground based and airborne systems. Propagation of e.g. radio waves, radio frequency signals or optical signals is facilitated by unobstructed line of sight, consequently will be limited by the curvature of the earth. Hence, this is limiting for the possible distance for maintained communication, and in order to solve this problem an over-the-horizon system can be used. Inexpensive over-the-horizon capable communication systems have in the last decades returned as an important area of research, and has become even more important due to the increased use of UAVs, Unmanned Aerial Vehicles.

A well known approach for providing over-the-horizon communication is by using satellites. This however, is a solution that often is associated with extensive administrative work and the availability is often limited. The not absolutely highest prioritized assignments might have to stand back, making it an unreliable or in some cases even a non existing way of communication. Also, the signals sent to and from satellites often become very weak due to the long distances, making them easy to block by jamming. This is also a very expensive way of managing over-the-horizon communication. Cost efficiency and robustness are two of the most important aspects for feasible over-the-horizon communication systems.

Another approach is to use UAVs or other, for this single purpose, advanced platforms able to receive and transmit e.g. radio frequency signals between nodes in a network. This approach is not only very expensive but it also requires, for this single purpose only, operational resources and personnel. This can also lead to operational constraints and infrastructural dependencies.

Yet another important aspect in order to obtain fast and reliable over-the-horizon communication is the distance between the nodes. The closer the nodes are to each other, the faster the communication, and the more reliable the communication, becomes. However, nodes located close to each other include another drawback; it makes it easier for enemies to locate the sending end node by detecting the radio signal. This is especially critical if the receiving end node is a missile, a UAV or such, which operates in hostile territory whereby the locating of the transmitting end node enables the enemy to take various precautions. There are several signal modification techniques available to prevent signal detection and interception but they often have limiting effects on the data rate that can be transmitted and they increase the complexity of the system, hence, the cost.

One way of addressing a few of the problematic areas related to over-the-horizon communication is by using the method disclosed in the U.S. Pat. No. 5,183,414. The patent publication discloses a method for providing high rate over-the-horizon communication using radio frequency signals for communication between the launch platform and the interface unit (relay station), and optical fibre communication between the interface unit and an autonomous vehicle platform. The autonomous vehicle platform, supposedly being a missile or a UAV, is preferably equipped with a real time viewing system for gathering optical data that can be used for responsive control, real time decision making, damage assessment etc.

The drawback with using an optical fibre for communication is e.g. the limitation of effective range and the difficulties to connect the end optical fibre connected unit to a multidirectional network. The using of optical fibre is by default limiting for multidirectional communication. The interface unit and/or the units, connected to each other with optical fibre, also need to be equipped with spools and/or bobbins, making them heavier and adding extra cost to the system, not to mention the constraints imposed with respect to manoeuvring. The considerable weight of the interface units also has a negative impact on the ability to keep the unit airborne, thus making it problematic to maintain the network connectivity over time.

It should also be mentioned that for some applications ionospheric wave propagation or ground wave propagation can be used as an alternative way for long distance communication. However, none of these approaches are sufficient for time critical systems or systems where the reliability is essential due to unpredictability and low reliability.

Thus, there is a need for improved systems for over-the-horizon communication.

### SUMMARY OF INVENTION

The present invention relates to a system for over-the-horizon communication by use of network extension nodes forming a network extension cluster, and methods for using, managing, deploying and providing said system. Communication is in this context either continuously maintained communication or single pieces of information sent, is either unidirectional or bidirectional and is in the form of data, any type on signal or like.

The inventive over-the-horizon communication system is intended to be used above the operating range for ground based antennas and below the operating range for satellites, between approximately tens of meters to tens of kilometres above sea level. Hence, the operating range exceeds the altitude range for high altitude clouds enabling communication over the clouds where the atmospheric impact is limited.

The end nodes can be any type of vehicle, any type of structure, a person, an apparatus or like which either is the initial transmitter or final receiver of a e.g. radio based transmission. The end nodes of the over-the-horizon communication system can be located on land, at sea and/or in the air and are in motion or at rest. The radio network extension nodes are any type of apparatus with the capability to forward or redirect radio based transmission, but also other means for communication such as e.g. laser can be used. The flexibility of the over-the-horizon communication system, comprising multiple end nodes and multiple network extension nodes, is possible due to the simplicity of the system.

According to one example of the inventive over-the-horizon communication system the invention discloses an over-the-horizon communication system comprising at least two end nodes, the end nodes being configured to receive and transmit communication signals. It further comprises at least two, in the troposphere and/or stratosphere airborne, network extension nodes that are communicatively connected to the end nodes and wherein the end nodes are arranged for communication with the network extension nodes and where the network extension nodes are arranged for bidirectional or unidirectional communication between the individual network extension nodes and communication with the end nodes, being either one end node or a plurality of end nodes. Troposphere and/or stratosphere are in this context equal to the altitude range below the altitude range where satellites communicate with each other. The troposphere and stratosphere reaches up to approximately 50 km above sea level. Using at least two network extension nodes enables the over-the-horizon communication system to be flexible and the redundancy, due to the use of multiple network extension nodes, makes the system reliable. The use of multiple network extension nodes is essential for the over-the-horizon communication system to work as intended.

According to one example of the over-the-horizon communication system the network extension nodes are radio network extension nodes, being configured to receive and transmit radio frequency signals. In this example, also the end nodes are configured to receive and/or transmit radio frequency signals, wherein the radio network extension nodes are connected by means of radio frequency based communication to the end nodes for bidirectional or unidirectional communication between the end nodes and the network extension nodes, and between the different network extension nodes. Using radio signals as means for communication is a robust and well tested concept, comprising proven technology, thus enabling an inexpensive concept. The used frequency for communication can be anywhere in the frequency range between 30 MHz and 100 GHz.

According to the inventive over-the-horizon communication system, depending on the purpose of the communication, or the type of message, data, signal etc. sent/received, the communication can be either unidirectional, meaning that the sending end node, with sending end node meaning the end node where the communication is initiated, is configured to only transmit communication but never receive communication, or bidirectional, meaning that the sending end node is configured to both receive and transmit communication. Generally, the extension nodes have to be configured both to receive communication from an end node or another extension node and to transmit communication to another extension node, or to one or several receiving end nodes. However, there are also applications of the inventive system where it is preferable that the network extension nodes are configured for unidirectional communication. The receiving end node, with receiving end node meaning the end node intended for receiving the communication sent from the sending end node, or where there are more than one end node—the receiving end nodes, can either be arranged for unidirectional communication, only being configured to receive communication, or bidirectional communication, being configured to both receive and transmit communication. Consequently, if the at least two end nodes both are arranged for bidirectional communication, the receiving end node is capable to respond to the communication sent from the sending end node, and the sending end node is capable of receiving the response sent in reply from the receiving end node. The inventive over-the-horizon communication system is not limited to comprise just two end nodes. It is possible to use both multiple sending end nodes and multiple receiving end nodes. Also, a sending and/or receiving end node do not have to communicate with the same network extension node/nodes continuously, this may vary over time.

In an example of the inventive over-the-horizon communication system where the network extension cluster comprises more than two network extension nodes, all extension nodes may not be connected to all other network extension nodes of the network extension cluster.

According to another example of the inventive over-the-horizon communication system the network extension nodes are unpropelled network extension nodes. In this context, unpropelled is used as a denomination assigning the unpropelled entity the attribute to not be driven by a motor, the opposite being propelled, or motor driven. Using unpropelled radio network extension nodes enables the over-the-horizon communication system to be relatively inexpensive. Rockets and like, using rocket motors, engines driven on pressurized gas or steam and like, are in this context considered to be unpropelled.

According to yet another example of the inventive over-the-horizon communication system the network extension nodes are arranged to become airborne by means of at least one of the means in a group of means comprising; deploying a balloon, by being launched in a trajectory, for example by being fired from a vehicle, and/or by being launched from another propelled or unpropelled object. In the embodiment where the network extension nodes are arranged to become airborne by means of deploying at least one balloon, for example by using a mechanism where the end node might deploy a balloon, filled with a gas lighter than surrounding air, making it ascend from the ground up into the sky. Depending on what type of balloon that is used and/or what type of gas that is used in order to make the balloon ascend, the balloon will burst at a certain altitude above sea level. Different balloons have different lifting capacity, thus giving the ascending radio network extension nodes, comprising balloons, different ascending velocity. The network extension nodes can also become airborne by being fired by means of some kind of artillery, cannon or such or one or more than one network extension nodes can become airborne by being released and/or partitioned from a propelled or unpropelled airborne object such as a UAV, a missile, a rocket, glider, balloon or such. Consequently, the network extension nodes of the over-the-horizon communication system can be launched from the ground and/or from a ground based, sea based and/or a flying launch platform and the launch platform can be in motion or at rest. The launch platforms are defined as all units with the possibility to either execute the launch or from which the launch can be executed, such as personnel, vehicles, facilities etc.

According to another aspect of the inventive over-the-horizon communication system the network extension nodes are arranged to become airborne by means of using energy stored in at least one spring or in at least one resilient means, or by means of energy stored as pressurized gas or steam. For certain embodiments this means of making the network extension node airborne may be the most advantageous.

According to another example of the inventive over-the-horizon communication system the network extension nodes are arranged to be airborne by means of at least one of the means in a group of means comprising; a balloon, a parachute and/or a glider or such that enables the network extension node to stay airborne, during descending or ascending, for a period of time. By using airborne extension nodes the over-the-horizon communication can be maintained during a longer period of time.

According to another example of the inventive over-the-horizon communication system at least one of the at least two network extension nodes comprises a GPS receiver and/or transmitter, and/or at least one of the at least two network extension nodes comprises a temperature and/or a pressure sensor and/or rangefinder and/or altimeter. Equipping the extension nodes with GPS receivers and/or transmitters and/or pressure and/or temperature sensors can give important information regarding the positioning etc. of the extension nodes.

According to yet another aspect of the inventive over-the-horizon communication system one of the end nodes can be a satellite.

Network extension nodes can also advantageously be used in order to facilitate communication with satellites. When communicating with satellites, the most significant signal losses and the altitudes where the signal is exposed to most interference, is the height range where clouds are present. Clouds are found almost exclusively in the troposphere, extending up to approximately 20 km above the ground. Some clouds may also be present in the stratosphere, if so particularly so called Nacreous clouds. The stratosphere is very dry due to that the vertical transfer is limited by the tropopause. However, not only clouds, consisting primarily of small water droplets and ice, have limiting effects on different kind of signals and influence the signals in a negative way, e.g. in regards of signal strength. Also the oxygen and water in the air, having the highest influence at ground level and thereafter decreasingly, influence the signals. Consequently, in regards of signal strength and minimized attenuation, the distance a signal has to travel through clouds/water/oxygen between the transmitter and the satellite is crucial. However, this is most significant at lower altitudes up to and including the altitudes where clouds are present, due to the higher concentration of oxygen in the air at lower altitudes, and the influence of moist, ice crystals etc. in the clouds. Approximately 99% of all water present in the atmosphere exists below an altitude of 20 km. The interference of the signal at altitudes above the clouds is less significant.

Consequently, one or preferably more than one radio network extension node can be deployed in order to minimize the distance a signal has to travel at altitudes of interference, meaning lower altitudes and altitudes where clouds are present. This is done according to;

instead of letting the signal travel diagonally from the end node located at land, through the interfering atmosphere and to the satellite;

letting the signal travel from the end node to the radio network extension nodes, which forms the cluster, through the interfering atmosphere, the radio network extension nodes being arranged to be located substantially vertically above the end node, and then letting the signal travel from the cluster to the satellite at an altitude with reduced atmospheric attenuation.

This will not only, according to the previously described advantages with using networks or clusters of nodes, make the communication more reliable due to redundancy etc., but also minimize the signal losses and interference due to that the signal will travel a shorter distance through altitudes of interference.

The distinctive characteristics for the examples of the over-the-horizon communication systems described above can be combined freely.

According to another example of the inventive over-the-horizon communication system the means for communication is optical, such as by means of laser. By using optical communication between the end node and the extension nodes, or between the extension nodes, the communication may be conducted in a more efficient way and other components, if desirable, can be used.

According to one aspect of the invention the invention comprises a method of communicating between at least a first end node and a second end node by using said over-the-horizon communication system. According to the inventive method, the first end node is communicating with at least a first network extension node by sending and/or receiving signals and/or data to/from at least the first network extension node. The first network extension node is communicating with at least a second network extension node by sending and/or receiving signals and/or data to/from at least the second network extension node and the first network extension node is communicating with the first end node by sending and/or receiving signals and/or data to/from the first end node. The second network extension node is communicating with at least the first network extension node by sending and/or receiving signals and/or data to/from the first network extension node and is communicating with at least the second end node by sending and/or receiving signals and/or data to/from the second end node. Finally, the second end node is communicating with at least the second network extension node by sending and/or receiving signals and/or data to/from the second network extension node. Both the first and the second end nodes and the network extension nodes can be connected, for bidirectional or unidirectional communication, with more than one network extension node. The network extension nodes can also be connected for bidirectional or unidirectional communication to more than one end node. Consequently, in the aspect of the invention described above may the first end node also be connected for bidirectional or unidirectional communication to the second network extension node and the second end node may also be connected for bidirectional or unidirectional communication to the first network extension node. Both the first and second end nodes, and the first and second network extension nodes, may also be connected to at least a third network extension node. Additionally, the first, second and third network extension nodes may also be connected for bidirectional or unidirectional communication to at least a third end node. The communication previously described may comprise sending and/or receiving any type of signals and/or data information. A method using the inventive over-the-horizon communication system enables communicating by using an inexpensive and redundant system.

In an example of a method of managing the over-the-horizon communication system the method comprises automatic activation and deactivation of the network extension nodes based on altitude, speed, elapsed time, distance, round trip timing and/or location for each of the network extension nodes comprised in the over-the-horizon communication system. Using predetermined criteria enables control of which radio network extension nodes of the over-the-horizon communication system that are active and inactive. For example, this feature can be used in order to facilitate that all transmitting radio network extension nodes are located within a predetermined area. Using certain prerequisites for activating and/or deactivating the network extension nodes is referred to as boundary control.

The distance between one end node and one network extension node can be controlled by using visual sensors and methods for image processing over time, according to well known principles for a person skilled in the art. Hence, this approach can be used in order to determine the distance between the end node and the network extension node, which in its turn can be used as decision basis for activation or deactivation.

In another example of a method of managing the over-the-horizon communication system the method comprises automatic deactivation of the radio network extension nodes, based on that the means for arranging the radio network extension nodes to be airborne cease to be active. For example, this feature can be used in order to facilitate that all transmitting radio network extension nodes are located within a predetermined height range. An example of this is deactivation when an extension node, being airborne by means of a balloon, is deactivated as the balloon bursts when reaching a certain height.

In an example of a method of providing over-the-horizon communication the method comprises selecting a communication path by using the activated and available network extension nodes, based on at least one predetermined criteria, wherein the criteria may be e.g. high signal strength, transfer capacity or low risk of jamming. This feature enables that best possible communication path, based on current conditions, is chosen. According to another example of a method of providing over-the-horizon communication, a randomly self-organizing-network is used, wherein the selected and used communication paths are varied according to a predetermined schedule. This approach is advantageously used in order to vary selected communication path in order to hamper interception.

The self-organizing-network is a network of multiple network extension nodes wherein the network extension nodes themselves can organize which communication path that is used based on for example any predetermined criteria, algorithms with adjustable variables or just randomness. The self-organizing-network can also, based on for example any predetermined criteria, algorithms with adjustable variables or just randomness, vary which end nodes that are part of the network, hence are available for the self-organizing-network, at any given time. According to one example of the inventive over-the-horizon communication system, the communication between the network extension nodes is managed by coordinated transmission, meaning that there is a predetermined or continuously adjusted plan regarding how the network extension nodes transmits and receives signals.

According to one aspect of the invention, an example of a method of deploying the over-the-horizon communication system comprises deploying the network extension nodes according to a predetermined schedule or randomly generated schedule. The method may further comprise that according to present or predicted availability of network extension nodes deploy network extension nodes in order to establish a network and/or continuously replacing the network extension nodes of said network and/or launching the network extension nodes according to a predetermined sequence.

According to yet another example of a method of deploying an over-the-horizon communication system the method comprises random or continuous deploying of network extension nodes according to a predetermined schedule or randomly generated schedule. This can for example be used in order to either establish a network or continuously replacing the network extension nodes in a network. One method may further comprise that the network extension nodes are deployed according to a randomly generated schedule in order to obstruct hostile jamming.

According to one example of the invention a method of deploying the over-the-horizon communication system comprises consecutively deploying the network extension nodes in sequence according to a predetermined prerequisite such as; the sequentially previously deployed network extension node reaching a predetermined height, reaching a predetermined distance from a predetermined spot, a combination of reaching a predetermined height and distance or that a predetermined period of time has elapsed since the sequentially previously deployed network extension node was deployed. In the aspects of the invention where radio signals are used as means for communication, a method of deploying the network extension nodes comprising that they are deployed when the radio frequency signal of the most recently deployed radio network extension node connects to the sequentially subsequent radio network extension node, can be used. This approach can also be used using optical communication. There are also other prerequisites, depending on current situation and circumstances, which might be relevant to apply. Preferred prerequisite for deploying network extension nodes is dependent on prevailing conditions and current mission.

According to another example a method of deploying the over-the-horizon communication system comprises launching the network extension nodes from at least one location, the location being the same as for any one of the end nodes or being anywhere in the vicinity of the route connecting the end nodes.

According to yet another example of the invention a method of deploying the over-the-horizon communication system comprises launching the network extension nodes according to a predetermined sequence or that the network extension nodes are launched in a trajectory in at least one direction such that the network extension nodes are launched in a predetermined or randomly generated pattern.

According to the invention, the preferred means of communication is by using radio based communication, using radio frequency signals, for bidirectional or unidirectional communication between the end nodes and extension nodes and for bidirectional communication between the extension nodes, but also other means for communication is possible, e.g. optical communication.

The above described examples and aspects of the inventive over-the-horizon communication system, and methods using said system, is generally just highlighting one specific feature of the invention. Hence, one embodiment of the invention may comprise the features from more than one example or aspect of the invention. Also, the invention is not to be seen as limited by the examples.

### BRIEF DESCRIPTION OF DRAWINGS

FIG. 1 shows a schematic example of an inventive over-the-horizon communication system;

FIG. 2 shows a schematic example of an inventive over-the-horizon communication system, wherein the network extension cluster is being deployed by means of two unpropelled objects being launched in a trajectory;

FIG. 3 shows another schematic example of an inventive over-the-horizon communication system;

FIG. 4 shows a graph indicating the activation and deactivation of extension nodes being airborne by means of a balloon or like, when being launched over a period of time;

FIG. 5 shows a graph indicating the activation and deactivation of extension nodes being airborne by means of a balloon or like, wherein the different balloons or like, for the different network extension nodes launched, have different ascending speeds, and are being launched over a period of time:

FIG. 6 shows a graph indicating the activation and deactivation of extension nodes being airborne by means of a balloon or like, and thereafter slowly descending by means of a parachute or like.

It should be added that the following description of the examples is for illustrative purposes only and should not be considered as limiting.

### REFERENCE SIGNS

A-G: End nodes A-G

1: Over-the-horizon communication system

2: Network extension node

3: Network extension cluster

4: Cannon or like

5: Network extension nodes, arranged to be airborne by means of parachutes

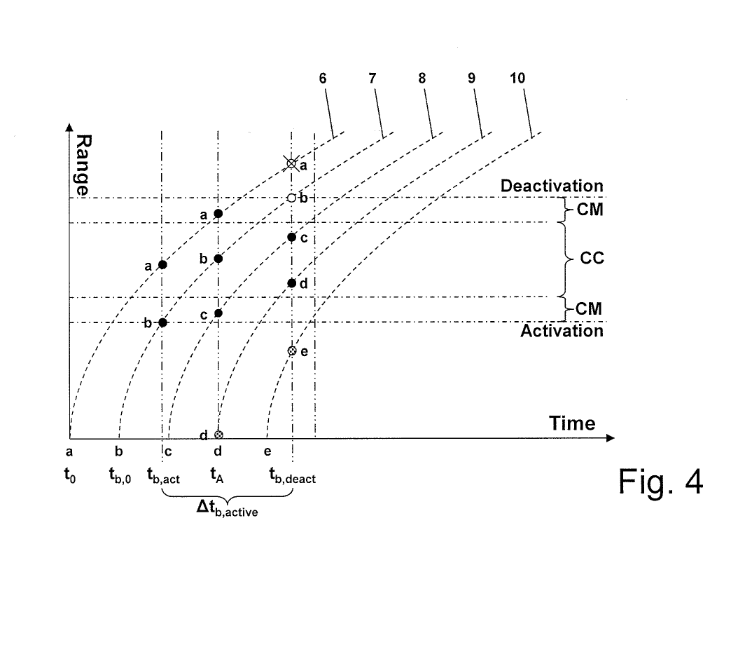

6: Time/range curve representing network extension node a according to FIG. 4

7: Time/range curve representing network extension node b according to FIG. 4

8: Time/range curve representing network extension node c according to FIG. 4

9: Time/range curve representing network extension node d according to FIG. 4

10: Time/range curve representing network extension node e according to FIG. 4

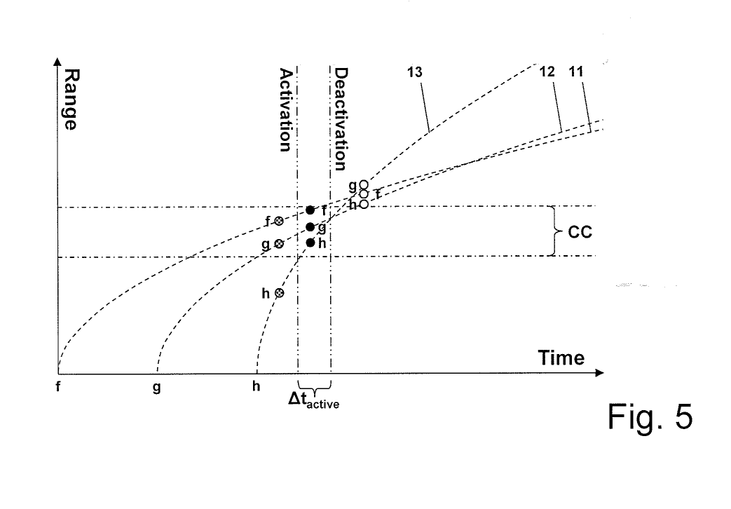

11: Time/range curve representing network extension node f according to FIG. 5

12: Time/range curve representing network extension node g according to FIG. 5

13: Time/range curve representing network extension node h according to FIG. 5

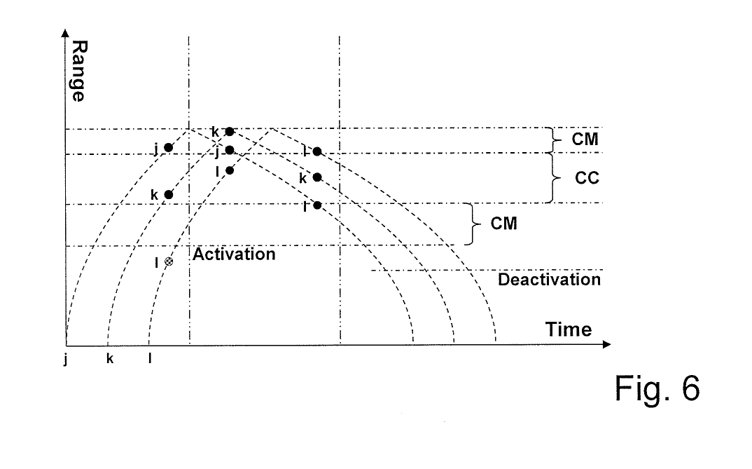

14: Time/range curve representing network extension node i according to FIG. 6

15: Time/range curve representing network extension node j according to FIG. 6

16: Time/range curve representing network extension node k according to FIG. 6

### DETAILED DESCRIPTION OF THE INVENTION

In the following figures one embodiment per figure of the invention is shown and described, simply for illustration of one mode of carrying out the invention.

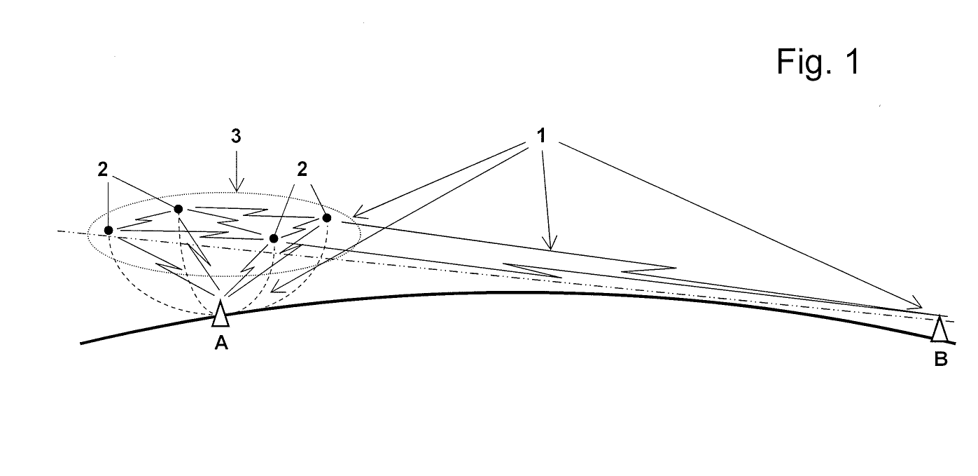

FIG. 1 shows a schematic example of the inventive over-the-horizon communication system 1, comprising end nodes A and B and a network extension cluster 3, consisting of four network extension nodes 2. The network extension nodes 2 are communicatively connected to end node A and end node B, facilitating over-the-horizon communication between end node A and B. End node A and B can be either receiving or transmitting end nodes, and can be arranged for unidirectional or bidirectional communication.

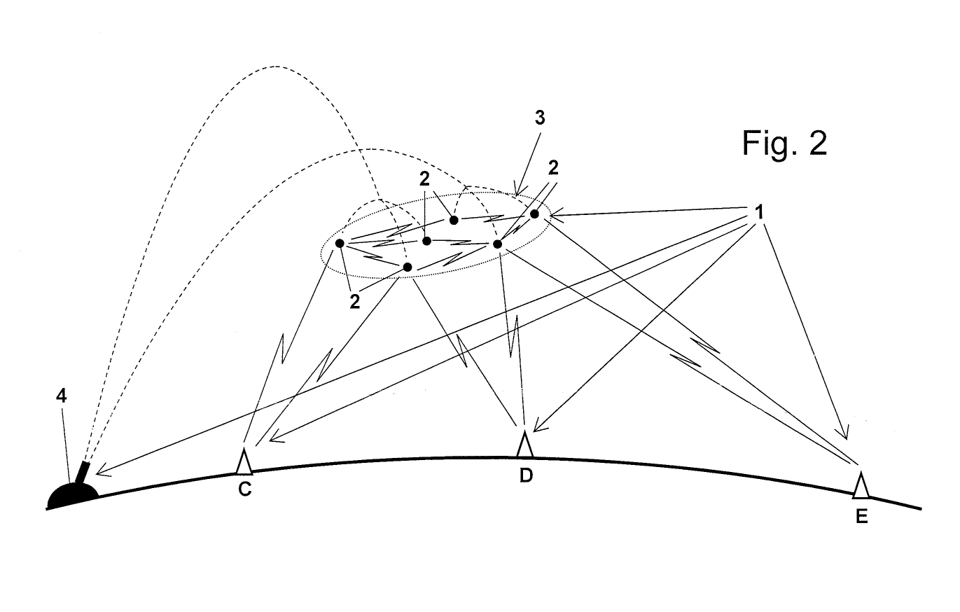

FIG. 2 shows an example of an inventive over-the-horizon communication system 1, wherein the network extension cluster 3 is being deployed by means of two unpropelled objects. Further, FIG. 2 shows a schematic illustration of the inventive over-the-horizon communication system 3 comprising three end nodes, end node C, end node D and end node E, and network extension nodes 2, wherein the network extension nodes 2, deployed by means of two unpropelled objects (not shown in picture), are being launched in a trajectory, wherein each of the unpropelled objects is being split into three network extension nodes 2. End nodes C, D and E may be different or identical to end nodes A and B. This is an example of how one unpropelled object, being fired as an artillery piece, grenade or like, can be split into two or more network extension nodes or one or several network extension nodes can be released from an unpropelled object. Corresponding arrangements, where one or more than one node is being released from, divided from or like, an unpropelled object, the unpropelled object being e.g. a rocket, is also possible.

The sending and/or receiving end nodes C, D and E are communicatively connected to each other via the network extension nodes 2, forming the inventive over-the-horizon communication system 1. According to FIG. 2 the unpropelled objects (not shown in picture), preferably being an artillery piece, is launched by means of artillery, a cannon or such, in the figure depicted by a schematic cannon 4.

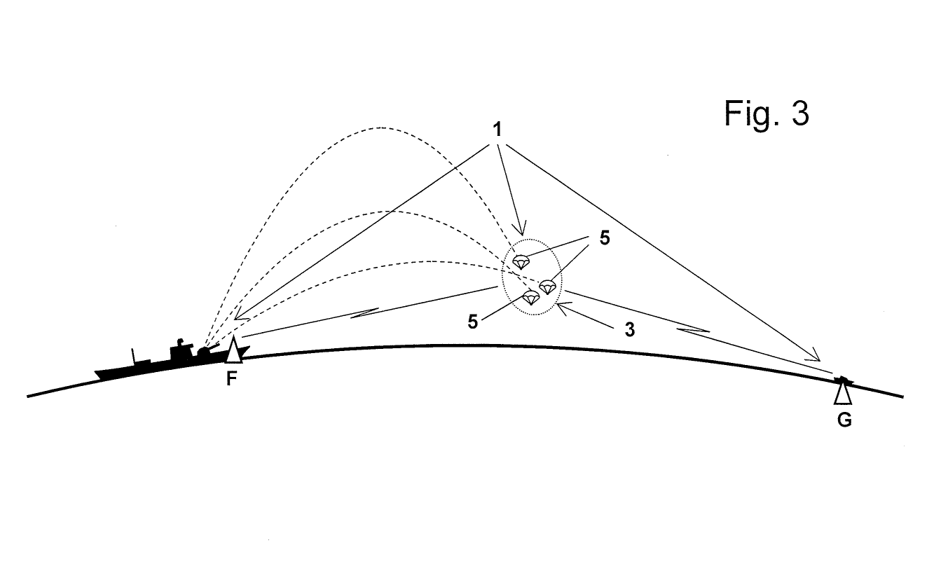

FIG. 3 shows another example of the inventive over-the-horizon communication system 1 wherein end node F is represented by a ship and end node G is represented by another, smaller ship. End nodes F and G may be different or identical to end nodes A-E, and are not limited to being ships. The inventive network extension cluster 3 is according to the embodiment of the invention established by means of network extension nodes 5 arranged to be airborne by means of parachutes after being fired from end node F, wherein end node F in FIG. 3 is depicted as a ship.

FIG. 4 shows how the implementation of one example of the over-the-horizon communication system can be depicted in a graph.

FIG. 4 shows a graph indicating the activation and deactivation of network extension nodes, being airborne by means of a balloon or like, when being launched over a period of time. The extension nodes a, b, c, d, e each represented by a range curve 6, 7, 8, 9, 10 in FIG. 4, are launched according to a predetermined and regular time interval. The y-axis represents the communication range for the extension nodes.

The over-the-horizon communication system is operational when at least two network extension nodes are active; in the graph in FIG. 4 indicated by the cluster coverage range CC, and the coverage margin CM. The Coverage margin CM is used in order to compensate for uncertainties in range.

For further clarification, the following schematic example, according to FIG. 4, can be assessed. For an extension node b being launched as number two in an order of launched network extension nodes, being represented by a range curve 7 in FIG. 4, the following applies:

t_{b,0} indicates the time the network extension node b is launched,

t_{b,act} indicates the time the network extension node b is activated,

t_{b,act}−t_{b,0}=Δt_{b,act} indicates the time passed from t_{b,0} until the network extension node b is activated,

t_{b,deact} indicates the time the network extension node b is deactivated,

t_{b,deact}−t_{b,act}=Δt_{b,active} indicates the period of time were the extension node b is active.

If Δt_{b} indicates a time passed since t_{b,0}.

If t_{b,act}>Δt_{b} the extension node b is not yet activated,

If t_{b,act}<Δt₂<t_{2,deact} the extension node b is activated,

If Δt_{b}>t_{b,deact} the extension node b is deactivated.

According to FIG. 4, at t_{A} the extension nodes a, b, c are active. Extension node d has just been launched and has not yet reached the Activation range, thus not yet been activated.

When the network extension nodes, according to the example in FIG. 4 being airborne by means of at least one balloon, reaches the deactivation range they are either automatically deactivated or have lost connection to the other network extension nodes and/or end nodes, and the balloon either bursts or continue to ascend further, depending on what type of balloon that is used. Also other means than balloons for making and keeping the network extension nodes airborne is possible.

Activation and deactivation linked to range is but one example of means possible for controlling the activation and deactivation of the network extension nodes.

FIG. 5 shows how the implementation of another example of the over-the-horizon communication system can be depicted in a graph.

FIG. 5 shows a graph indicating the activation and deactivation of extension nodes being airborne by means of a balloon or like, wherein the different balloons or like, for the different network extension nodes launched, have different ascending speeds, and are being launched over a period of time. According to FIG. 5 the network extension nodes f, g, h, each represented by a range curve 11, 12, 13 in FIG. 5, are launched with different ascending speed, as can be understood from the different slope of each network extension node's range curve 11, 12, 13. In FIG. 5 the ascending speed of each network extension node is adapted so that each network extension node is active within the same period of time, in FIG. 5 being indicated by Δt_{active}, the time between Activation and Deactivation. Activation and Deactivation do not necessarily have to be linked to a certain time or time passed. Also parameters as altitude, distance etc. can be used.

This is but one example of how the different properties of the network extension nodes, where the properties are depending on e.g. used means for making the network extension node airborne, used means for keeping the network extension node airborne, the design of the network extension node as such etc. can be tailored in order to fulfil any specific requirements of the inventive over-the-horizon communication system. In this example the requirement possibly is to have an active over-the-horizon communication system, comprising three network extension nodes, active at a certain time indicated by Δt_{active}. Before the network extension nodes reaches the time for activation they are not yet activated and when they have passed the time for deactivation they are deactivated.

FIG. 6 shows how the implementation of a further example of the over-the-horizon communication system can be depicted in a graph.

FIG. 6 shows a graph indicating the activation and deactivation of extension nodes being airborne by means of a balloon or like, and thereafter slowly descending by means of a parachute or like. According to the graph, assumingly depicting a scenario where the network extension nodes are arranged to be airborne by means of a balloon, the network extension nodes ascend until they reach a height where either the balloon or like bursts or the network extension node is released from the balloon arrangement. When reaching maximum coverage range, indicated by the upper limit of the upper coverage margin, CM, the network extension nodes start to slowly descend, preferably by means of a parachute or like. The network extension nodes are being activated as they reach the activation level on their way up, and deactivated as the reach the deactivation level on their way down. The deactivation level can be predetermined, based on various parameters such as time passed since activation, height etc., and can be either within the lower coverage margin CM or as in the example in FIG. 6, below the coverage margin. The deactivation can also be individually adapted for the network extension nodes according to prevailing circumstances. The deactivation may e.g. be affected by that the wind is carrying the network extension node in undesirable direction.

The slow descending by means of a parachute or like may be initiated by the balloon bursting, or loosing lifting capacity in some other way, in a controlled or spontaneous way. The deployment of the parachute may be initiated for example; by the balloon bursting, by the network extension node being released at a certain height, by the ascending network extension node reaching a predetermined height, automatically as the network extension nodes starts to descend, by acceleration or according to other method.

As will be realised, the invention is capable of modification in various obvious respects, all without departing from the scope of the appended claims. The FIGS. 1-6 are only intended to demonstrate a few selected examples of how the inventive over-the-horizon communication system can be used and how it can be controlled, and are not to be considered as limiting the scope of the invention. Accordingly, the drawings and the description thereto are to be regarded as illustrative in nature, and not restrictive.

All figures are schematically illustrated.

1-12. (canceled)

13. An over-the-horizon communication system (1) comprising:
at least two end nodes (A-G), the end nodes (A-G) being configured to receive and transmit communication signals and for providing communication between the at least two end nodes (A-G);
at least two, in at least one of a troposphere or a stratosphere airborne, network extension nodes (2;5), the network extension nodes (2;5) being communicatively connected to the end nodes (A-G), the end nodes (A-G) being configured for communication with the network extension nodes (2;5), and the network extension nodes (2;5) being configured for communication between the individual network extension nodes and communication with the end nodes (A-G),
wherein at least one of the at least two network extension nodes (2;5) comprises at least one of: a GPS transmitter/receiver, a temperature sensor, a pressure sensor, a rangefinder, or an altimeter.

14. An over-the-horizon communication system (1) according to claim 13, wherein
the network extension nodes (2;5) are configured to receive and transmit radio frequency signals;
the end nodes (A-G) are configured to receive and transmit radio frequency signals; and
the radio network extension nodes are connected by means of radio frequency based communication to the end nodes (A-G) for communication.

15. An over-the-horizon communication system (1) according to claim 13, wherein:
the system further comprises means at least one of for communication between at least one of the end nodes (A-G) and at least one the network extension nodes (2;5) or for communication between at least two of the network extension nodes (2;5); and
the means for communication are optical, such as by means of laser.

16. An over the-horizon-communication system (1) according to claim 13, wherein:
the communication between the end nodes (A-G) and the network extension nodes (2;5) are at least one of bidirectional or unidirectional; and
the communication between the network extension nodes (2;5) is at least one of bidirectional or unidirectional.

17. An over-the-horizon communication system (1) according to claim 13, wherein the network extension nodes (2;5) are unpropelled network extension nodes (2;5).

18. An over-the-horizon communication system (1) according to claim 13, wherein the network extension nodes (2;5) are configured to be airborne by at least one of a balloon, a parachute, or a glider.

19. An over-the-horizon communication system (1) according to claim 13, wherein:
the network extension nodes (2;5) are configured to become airborne by at least one of deploying a balloon, being launched in a trajectory, or being launched from at least one of a propelled or an unpropelled object.

20. A method of communicating between at least a first end node (A-G) and a second end node (A-G) by using an over-the-horizon communication system (1) comprising the first and second end nodes (A-G), wherein the method comprises the steps of:
the first end node (A-G) communicating with at least a first network extension node (2;5) by at least one of sending or receiving at least one of signals or data at least one of to or from at least the first network extension node (2;5);
the first network extension node (2;5) communicating with at least a second network extension node (2;5) by at least one of sending or receiving at least one of signals or data at least one of to or from at least the second network extension node (2;5);
the first network extension node (2;5) communicating with the first end node (A-G) by at least one of sending or receiving at least one of signals or data at least one of to or from the first end node (A-G);
the second network extension node (2;5) communicating with at least the first network extension node (2;5) by at least one of sending or receiving at least one of signals or data at least one of to or from the first network extension node (2;5);
the second network extension node (2;5) communicating with a second end node (A-G) by at least one of sending or receiving at least one of signals or data at least one of to or from the second end node (A-G); and
the second end node (A-G) communicating with at least the second network extension node (2;5) by at least one of sending or receiving at least one of signals or data at least one of to or from the second network extension node (2;5),
wherein the method further comprises the step of automatic activation and deactivation of the network extension nodes (2;5) based on at least one of an altitude, a speed, an elapsed time, a distance, or a location, for each of the network extension nodes (2;5) in the over-the-horizon communication system (1).

21. A method of providing over-the-horizon communication according to claim 20 wherein the method further comprises the step of selecting a communication path by using the activated and available network extension nodes (2;5) and based on at least one predetermined criteria, wherein the criteria comprises at least one of a high signal strength, a transfer capacity, or a low risk of hostile jamming.

22. A method of providing over-the-horizon communication according to claim 21, wherein the communication paths are varied according to a predetermined schedule.

23. A method of deploying the over-the-horizon communication system (1) according to claim 20, wherein the method further comprises the step of deploying the network extension nodes (2;5) according to at least one of a predetermined schedule or a randomly generated schedule.

24. A method of deploying the over-the-horizon communication system (1) according to claim 20, wherein the method further comprises the step of consecutively deploying the network extension nodes (2;5) in sequence according to a predetermined prerequisite such as the sequentially previously deployed network extension node (2;5) reaching at least one of a predetermined height or distance, or a predetermined period of time having elapsed since a sequentially previously deployed network extension node (2;5) was deployed.
